(19) United States
(12) Patent Application Publication
(10) Pub. No.: US 2005/0258249 A1
(43) Pub. Date: Nov. 24, 2005

(54) Imaging pixel array with programmable pixel aspect ratio for an optical code reader

(76) Inventors: James R. Giebel, Centerport, NY (US); Brad Carlson, Northport, NY (US); Constanzo DiFazio, East Patchogue, NY (US); Daniel F. Brown, East Northport, NY (US); Thomas D. Bianculli, Manorville, NY (US)

Correspondence Address: David M. Carter;Carter, DeLuca, Farrell & Schmidt, LLP, Suite 225, 445 Broad Hollow Road, Melville, NY, 11747, US

(21) Appl. No.: 10/834,763

(22) Filed: Apr. 29, 2004

(51) Int. Cl. G06K 7/10

(52) U.S. Cl. 235/462.11

(57) ABSTRACT

A programmable imaging pixel array and barcode imager incorporating the same are provided where the aspect ratio of each pixel of the imaging pixel array can be changed to better match the type of barcode being imaged. For lower density barcodes that are far away from the barcode imager, for example, the aspect ratio of the imaging pixel array can be programmed on the fly to maximize aspect ratio and thereby increase the signal-to-noise ratio in the received signal. When reading high density barcodes, such as PDF417 barcode symbols, the aspect ratio of the imaging pixel array can also be programmed on the fly to obtain an aspect ratio which does not compromise the performance of the barcode imager.

### BACKGROUND OF THE INVENTION

1. Field of the Invention

The present disclosure relates to the field of imaging, and specifically to imaging circuitry having an imaging pixel array with a programmable pixel aspect ratio for an optical code reader.

2. Description of the Related Art

CCD or CMOS-based imaging devices, such as barcode imagers, generally have a CCD array or other imaging pixel array having a plurality of photosensitive elements or pixels. Each pixel of the pixel array has a fixed aspect ratio (i.e., width-to-height). The aspect ratio of the pixels is generally determined by the type and/or density of the images, e.g., bar codes, to be read by the imaging device.

For reading lower density barcodes, or poorly printed lower density barcodes, pixels with large aspect ratios are more desirable. A pixel with a large aspect ratio provides the benefits of increasing the light collection area and reducing the noise produced by the pixel itself (increasing signal-to-noise (S/N) ratio), as well as filtering out or integrating small defects or voids found in the barcode.

This same large aspect ratio pixel, however, generally compromises the imaging device's performance on correctly reading higher density barcodes, such as PDF417 barcode symbols. In particular, the imaging device's tilt performance, or ability to correctly read a barcode when the imaging device is angularly positioned from the barcode, is compromised by the large pixel aspect ratio. To improve the tilt performance of the imaging device, the aspect ratio of each pixel of the imaging pixel array needs to be small so as to minimize smearing from adjacent elements of the barcode. Reducing the aspect ratio, however, reduces the signal-to-noise (S/N) ratio because the light collection area is reduced, and the noise contributed by each pixel is increased.

Furthermore, smaller pixels generally require more light for illumination and require longer shutter (exposure) time to improve the S/N ratio, resulting in a system which requires more power for illumination and longer processing times.

According to the above, there exists a need in the field of imaging for imaging circuitry that can be incorporated within an image-based one- or multi-dimensional barcode imager for imaging both low and high density indicia or symbols, including barcodes, labels, markings, pictures, etc., without compromising the performance of the optical code reader.

### SUMMARY OF THE INVENTION

An aspect of the present disclosure is to provide imaging circuitry having a programmable imaging pixel array, such as a programmable CMOS imaging array, which improves the signal-to-noise (S/N) ratio by combining the signal outputs of two or more adjacent pixels of the imaging pixel array. This results in a summation of the generated charge carriers from the single pixels and reduces readout time (e.g., fewer pixels to read).

The imaging circuitry having a programmable imaging pixel array and barcode imager incorporating the same of the present disclosure achieve this and other aspects by allowing the aspect ratio of each pixel of the imaging pixel array to be changed to better match the type of barcode being imaged. For lower density barcodes that are far away from the barcode imager, for example, the aspect ratio of the imaging pixel array can be programmed on the fly to optimize the aspect ratio and thereby increase the signal-to-noise (S/N) ratio in the received signal. When reading high density barcodes, such as PDF417 barcode symbols, the aspect ratio of the imaging pixel array can also be programmed on the fly to obtain an aspect ratio which does not compromise the performance of the barcode imager.

### BRIEF DESCRIPTION OF THE DRAWINGS

Various embodiments of the present disclosure will be described herein below with reference to the figures wherein:

FIG. 1 is a schematic illustration of imaging circuitry in accordance with a first embodiment of the present disclosure;

FIG. 2A is a schematic illustration of imaging circuitry in accordance with a second embodiment of the present disclosure;

FIG. 2B is a partial schematic of a pixel array and switching circuitry employed in the imaging circuitry in accordance with an embodiment of the present disclosure;

FIG. 2C is a partial schematic of an another array employed in the imaging circuitry in accordance with an embodiment of the present disclosure;

FIG. 2D is a partial schematic of an another array employed in the imaging circuitry in accordance with an embodiment of the present disclosure;

FIG. 3 is a perspective view of a barcode imaging system in accordance with the present disclosure;

FIG. 4 is a phantom side view of a barcode imager of the barcode imaging system shown by FIG. 3; and

FIG. 5 is a schematic illustration of a scanner-on-a-chip configuration in accordance with an embodiment of the present disclosure.

### DETAILED DESCRIPTION OF THE PREFERRED EMBODIMENTS

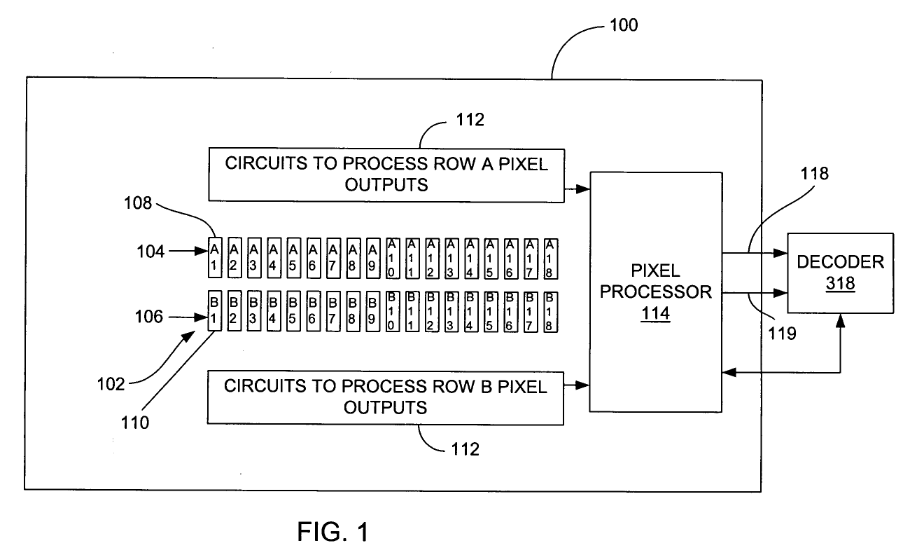

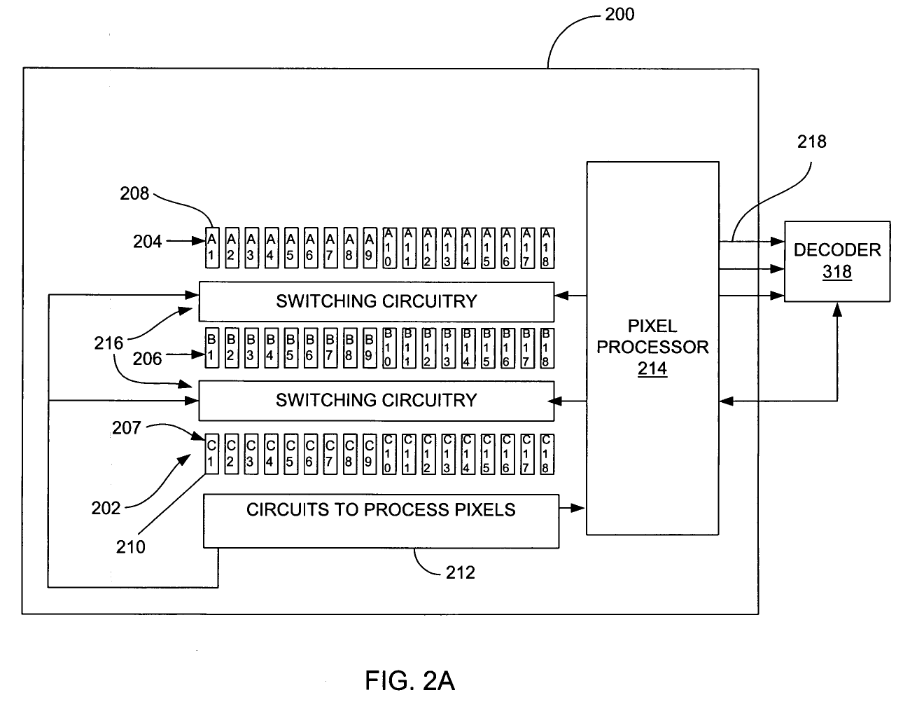

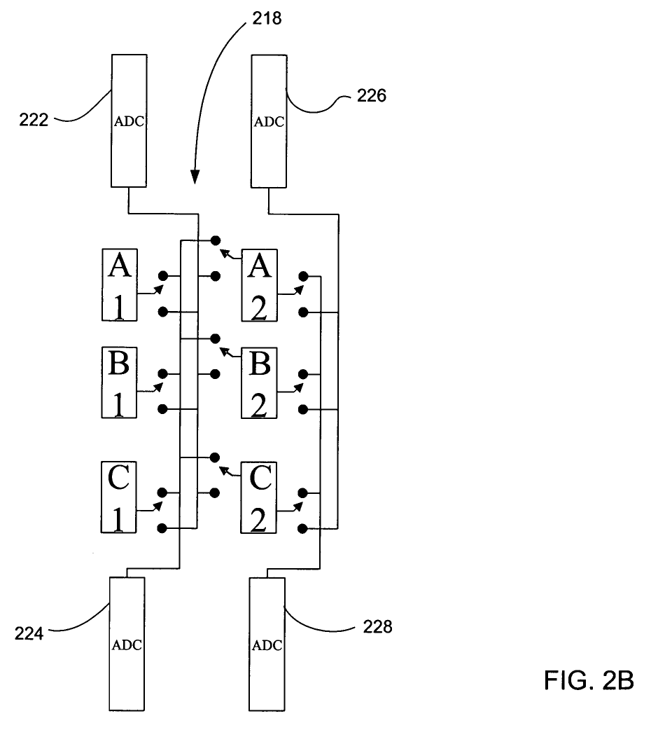

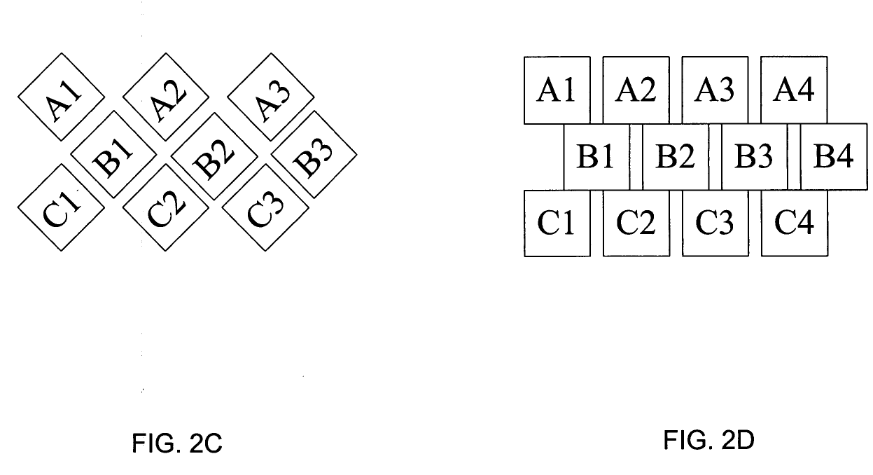

With reference to FIGS. 1 and 2A, two different embodiments of imaging circuitry having a programmable imaging pixel array according to the present disclosure are illustrated. The first embodiment is designated generally by reference numeral 100 and the second embodiment is designated generally by reference numeral 200. The imaging circuitry as shown by FIGS. 1 and 2A and described herein are suitable for imaging various optical codes or targets, such as labels, markings, pictures, postal codes, direct part marking (DPM) symbologies, etc., and especially suitable for imaging and reading one- and multi-dimensional barcode symbols, such as a Universal Product Code (UPC) barcode and the PDF417 barcode, without compromising the performance of the barcode imager.

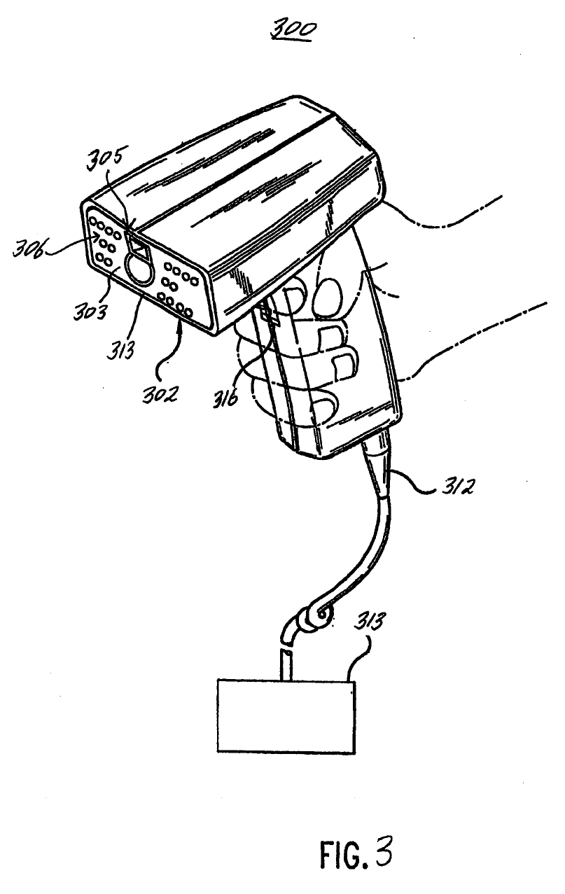

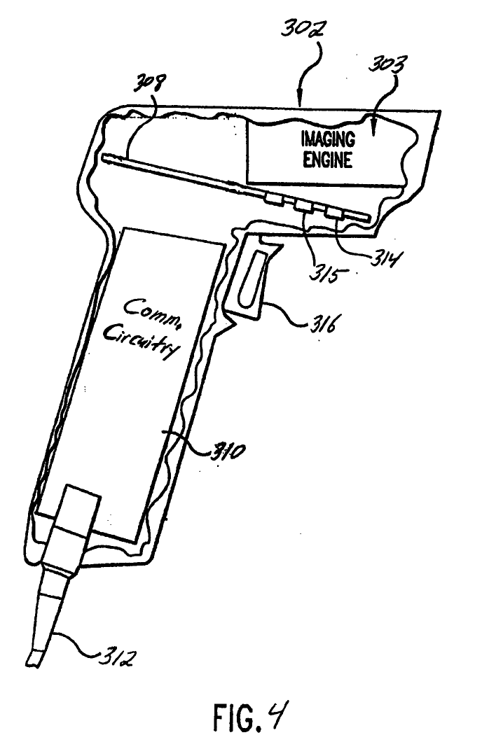

FIG. 3 illustrates a barcode imaging system designated generally by reference numeral 300. The barcode imaging system 300 includes one of the several embodiments of the imaging circuitry incorporated therein for imaging and decoding a barcode symbol (or imaging and processing labels, markings, pictures, etc.).

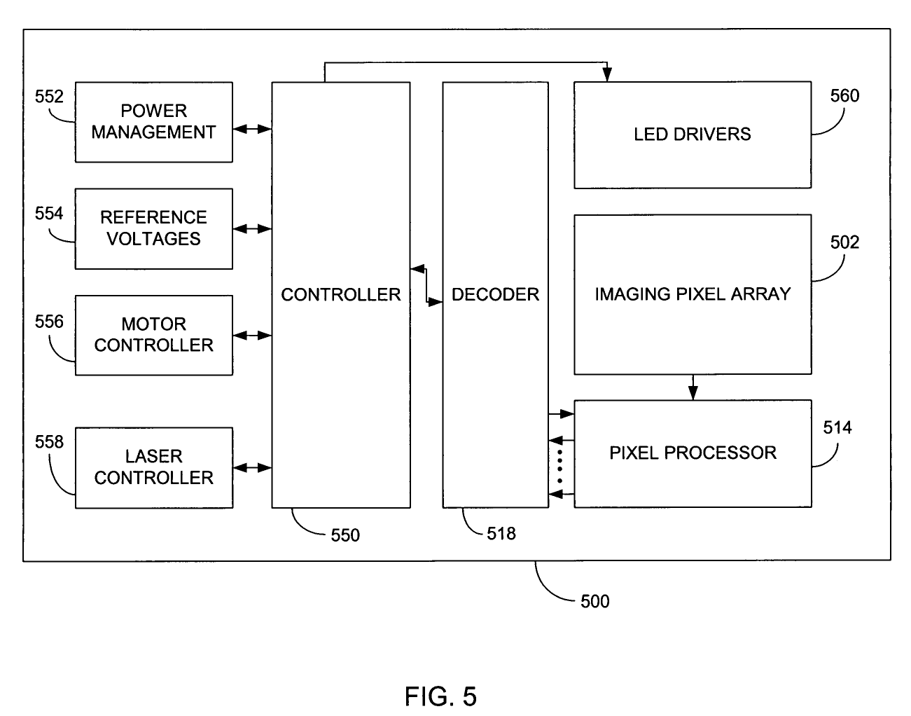

It is preferred that the imaging circuitry 100, 200 or portions thereof are provided or packaged in the form of an imaging engine 303 as shown by FIGS. 3 and 4 or as a scanner-on-a-chip 500 as shown in FIG. 5. The imaging engine 303 is configured and dimensioned for fitting within a predetermined form factor 313 of a barcode imager 302, such as the SE1200 form factor developed by Symbol Technologies, Inc. of Holtsville, N.Y., the assignee of the present disclosure. The imaging engine 303 includes either hard-wire connections or a wireless protocol for communicating data signals read out from an imaging pixel array of the imaging engine 303 to a decoder 318. Alternatively, the chip 500 is configured and dimensioned for fitting within another form factor (not shown) and adapted to communicate to various other systems.

### First Embodiment

With reference to FIG. 1, imaging circuitry according to a first embodiment of the present disclosure is shown and designated generally by reference numeral 100. Imaging circuitry 100 includes an imaging pixel array 102, such as a CMOS imaging array, having a first row of pixels 104 (e.g., pixels A1-A18) and a second row of pixels 106 (e.g., pixels B1-B18). The first and second rows of pixels are independent of each other. Each row of pixels includes a plurality of pixels 108 for capturing an image. Additionally, pixels 108 of the first row of pixels 104 correspond to pixels 108 of the second row of pixels 106 to form a plurality of pixel columns 110. It is contemplated that additional rows of pixels can be provided to form a larger imaging pixel array. By employing at least two rows of pixels, a system including the imaging circuitry of the present disclosure may acquire picture images as well as barcodes with a hand swiping motion over the image to capture, for example, a signature or a finger print. With two rows of pixels, an imaging system, e.g., an optical code reader, can better remove hand jitter and blur from an image as velocity information is more readily available to the system. It is to be appreciated that the several figures illustrate a simple implementation for explanation purposes and clarity, however, a practical device would include hundreds or thousands of pixels in each row.

Each pixel 108 generates a pixel signal corresponding to a portion of the image captured by the pixel 108. The pixel signals from each row of pixels 104, 106 are transmitted to corresponding processing circuits 112 where the pixel output data provided by each pixel signal are processed. The processing circuits 112 include conventional pixel processing circuits as known in the art for processing the pixel output data, for example, analog-to-digital converters (ADC).

The imaging circuitry 100 further includes a pixel processor 114 for obtaining the processed pixel output data corresponding to each pixel 108 from the processing circuits 112. It is contemplated that the processing circuits 112 can be integrated within the pixel processor 114. Preferably, the pixel processor 114 is a state machine that executes a series of programmable instructions for evaluating the processed pixel output data corresponding to each pixel 108 of the imaging pixel array 102. Based upon the evaluation, the pixel processor 114 determines whether or not to combine or add the pixel signals from any pixel in either row 104, 106, e.g., pixel A1-A18 and pixel B1-B18, thereby varying the aspect ratio of the imaging pixel array 102.

That is, the pixel processor 114 determines whether or not to combine or add the pixel signal corresponding to the leftmost pixel A1 of the first row 104 with the pixel signal corresponding to the leftmost pixel B1 of the second row 106; the pixel signal corresponding to the pixel adjacent to the leftmost pixel A2 of the first row 104 with the pixel signal corresponding to the pixel adjacent to the leftmost pixel B2 of the second row 106; and so on up to the pixel signal corresponding to the rightmost pixel A18 of the first row 104 with the pixel signal corresponding to the rightmost pixel B18 of the second row 106. Furthermore, the pixel processor 114 may combine any two pixels from either row to increase the S/N ratio. For example, under tilt conditions, the pixel processor may combine pixels A2 and B1 to compensate for rotation of the pixel array 102 using autocorrelation techniques as are known in the art. It is further contemplated that the pixels may be combined on a blind cycling scheme to deliver different pixel combinations on a scan by scan basis. For example, after a first scan, just pixels in the first row 104 are used; after a second scan, only pixels in the second row 106 are used; after a third scan, pixels in the first 104 and second 106 row may be combined; and any subsequent scan may combine any random combination of pixels from either the first or second row. It is to be appreciated that several hundreds or thousands of scans of a target will occur upon a single activation of the imaging circuitry without an appreciable delay to the user.

The determination entails determining whether or not the pixel signals as received from the processing circuits 112 and corresponding to the first and second rows 104, 106 would enable decoder 318 to correctly decode the pixel output data transmitted by the pixel signals. If the pixel output data corresponding to either the first or second row of pixels are determined to be decodeable, then the pixel processor 114 determines not to combine or add the pixel signals of corresponding columns 110 of the imaging pixel array 102. The pixel output data as received by the pixel processor 114 are then transmitted to the decoder 318 via channels 118, 119 corresponding to each row.

On the other hand, if the pixel output data corresponding to either the first and second row of pixels are determined to be non-decodeable, then the pixel processor 114 determines to combine or add the pixel signals of corresponding columns 110 of the imaging pixel array 102 in an effort to obtain and transmit a signal to the decoder 318 having decodeable output data. Hence, the imaging pixel array 102 is in effect programmable, since the pixel processor 114 can alter the aspect ratio of the imaging pixel array 102 on the fly to optimize aspect ratio, thereby increasing the signal-to-noise (S/N) ratio in the signal transmitted to the decoder 318.

The pixel processor 114, or the decoder 318, determines whether the pixel output data are decodeable by evaluating one or more of at least the following factors: whether the pixel output data corresponds to a low or high density barcode; the amount of ambient lighting as determined by the array of the barcode imager and/or by analyzing the contrast of the image; whether the imaging pixel array 102 of the barcode imager 302 is tilted or at an angle with respect to the optical code (e.g., barcode) or other indicia/target being imaged; the type of surface the optical code or other indicia/target being imaged is positioned on, such as, for example, a curved surface, a reflective surface (e.g., metallic surface), and/or an irregular (non-smooth) surface; and the distance the imaging pixel array 102 is positioned from the optical code or other indicia/target being imaged as determined by a distance determining assembly of the barcode imaging system 300. In one embodiment, the pixel processor 114 may be a state machine that could autonomously decide how to best combine pixels, or, if a more powerful decoder 318 is employed in the system 100, the pixel processor 114 could be commanded to enter a slave mode where the decoder 318 would then control and decide how to best combine pixels.

Using at least the above factors and/or the fact that by doubling the aspect ratio of the imaging pixel array 102 still resulted in non-decodeable output data, the pixel processor 114 can determine to combine or add the pixel signals of two or more consecutive columns to further increase the aspect ratio of the imaging pixel array 102. For example, the pixel processor 114 can determine to combine the pixel signals of a first column to obtain a first combined pixel signal and to also combine the pixel signals of an adjacent column to obtain a second combined pixel signal. The pixel processor 114 would then combine or add the first and second combined pixel signals. Accordingly, the aspect ratio of the imaging pixel array 102 is further increased as compared to only combining or adding the pixel signals of a single column of the imaging pixel array 102 in an effort to output decodeable output data to the decoder 318.

Alternatively or simultaneously, the pixel processor 114 could process the pixel signals of each row of pixels, i.e., rows 104 and 106, independently using signal processing techniques to obtain a digital signal output for each row. The pixel processor 114 would then send the output of each row to the decoder 318 via channels 118, 119, e.g., an analog or a digital interface, where additional signal processing would be provided. The decoder 318, for example, could use autocorrelation techniques to combine pixels across pixel columns to eliminate blur and smearing in the high tilt case to obtain a composite output signal with improved signal-to-noise (S/N) characteristics. By performing this methodology in the alternative or simultaneously with the methodology of increasing the aspect ratio of the imaging pixel array 102, the imaging circuitry 100 provides a high degree of confidence that the output data are decodeable.

The pixel processor 114 could also determine, or be instructed by the decoder 318, not to combine the signal outputs of each row, but rather transmit to the decoder 318 the output of one or both rows simultaneously, or staggered in time. This method is particularly applicable where the barcode imager 302 is positioned at an angle or is tilted with respect to the barcode or other indicia to be imaged and the pixel processor 114 determines that one row of the imaging pixel array 102 provides a better image (e.g., a better focused image) of the barcode than the other row. Furthermore, staggering the output signals increases the scan rate of the array to remove sensitivity to hand jitter or other movements, i.e., the sampling rate of the array is doubled.

### Second Embodiment

With reference to FIG. 2A, imaging circuitry according to a second embodiment of the present disclosure is shown and designated generally by reference numeral 200. Imaging circuitry 200 includes an imaging pixel array 202, such as a CMOS imaging array, having a first row of pixels 204, a second row of pixels 206 and a third row of pixels 207. The first, second and third rows of pixels are independent of each other. Each row of pixels includes a plurality of pixels 208 for capturing an image. It is contemplated that additional rows of pixels can be provided to form a larger imaging pixel array.

Each pixel 208 generates a pixel signal corresponding to a portion of the image captured by the pixel 208. Selective pixel signals are then processed by processing circuits 212, e.g., analog-to-digital converters (ADC). The processing circuits 212 process the pixel signals corresponding to the first row of pixels 204, the pixel signals corresponding to the second row of pixels 206, the pixel signals corresponding to the third row of pixels 207 and any combination thereof. The last processing methodology entails adding the pixel signals from the various rows to increase the aspect ratio of the imaging pixel array 202.

The processing circuits 212 may include a series of programmable instructions for determining whether to process the pixel signals corresponding to the first row of pixels 204, the pixel signals corresponding to the second row of pixels 206, the pixels signals corresponding to the third row of pixels 207 or the pixel signals corresponding to the first, second or third rows of pixels. The series of programmable instructions evaluates or analyzes the pixel signals of each row to determine if the pixel signals of at least one of the two rows includes decodeable pixel output data. The processing circuits 212 will select appropriate rows or pixels to be processed via switching circuitry 216, as will be described below.

The processing circuits 212 determine if the pixel signals include decodeable pixel output data by evaluating or analyzing the focus quality, contrast, sharpness, etc. of the image represented by the pixel output data. If the focus quality, contrast, sharpness and/or other characteristic of the image is determined, for example, to be greater or equal than a predetermined threshold, then the pixel output data are determined to be decodeable; if it is determined to be less than a predetermined threshold, then the pixel output data are determined to be non-decodeable.

To reduce processing time, the processing circuits 212 evaluate or analyze the pixel signals corresponding to the first row of pixels 204 to determine if these pixel signals include decodeable pixel output data using at least one or more of the factors described above for the first embodiment. If they do, the pixel output data corresponding to the first row of pixels 204 are transmitted to a pixel processor 214. The pixel processor 214 then determines whether the pixel output data corresponding to the first row of pixels 204 corresponds to a one-dimensional barcode. If it does, the pixel output data are transmitted to the decoder 318 where the pixel output data corresponding to the first row of pixels 204 are decoded.

If the pixel output data corresponding to the first row of pixels 204 do not correspond to a one-dimensional barcode, i.e., the pixel output data corresponds to a two-dimensional barcode, the pixel output data are stored in a memory of the decoder 318 while awaiting for subsequent pixel output data, in order for all the pixel output data corresponding to the two-dimensional barcode to be transmitted to the decoder 318 substantially simultaneously.

If it is determined by the processing circuits 212 that the pixel signals corresponding to the first row of pixels 204 does not include decodeable pixel output data, the processing circuits 212 evaluate or analyze the pixel signals corresponding to the second row of pixels 206 to determine if these pixel signals include decodeable pixel output data using at least one or more of the factors described above for the first embodiment. If they do, the pixel output data corresponding to the second row of pixels 206 are transmitted to a pixel processor 214. The pixel processor 214 then determines whether the pixel output data corresponding to the second row of pixels 206 corresponds to a one-dimensional barcode. If it does, the pixel output data are transmitted to the decoder 318 where the pixel output data corresponding to the second row of pixels 206 are decoded.

If the pixel output data corresponding to the second row of pixels 206 do not correspond to a one-dimensional barcode, i.e., the pixel output data corresponds to a two-dimensional barcode, the pixel output data, as described above for the first row of pixels 204, are stored in a memory of the pixel processor 214 while awaiting for subsequent pixel output data, in order for all the pixel output data corresponding to the two-dimensional barcode to be transmitted to the decoder 318. The above methodology will be repeated for the third and any other subsequent rows.

If it is determined that the pixel output data corresponding to the first row of pixels 204, the pixel output data corresponding to the second row of pixels 206 and the pixel output data corresponding to the third row of pixels 207 are non-decodeable, the processing circuits 212 and/or pixel processor 214 then determines to combine or add (sum) the pixel signals corresponding to the first row of pixels 204, the second row of pixels 206, the third rows of pixels 207 or any combination thereof to increase the aspect ratio of the imaging pixel array 202. The combination of the pixel signals occurs by switching circuitry 216 associate with each pixel to combine or add (i.e., sum) the pixel signals of each pixel to increase the aspect ratio of the imaging pixel array 202. Alternatively, if a more powerful decoder 318 is employed in the system 200, the pixel processor 214 could be commanded to enter a slave mode where the decoder 318 would then decide how to best combine pixels.

As shown in FIG. 2B, a plurality of switches 218 are preferably provided within an integrated chip 216 which receives signals from the processing circuits 212 and/or pixel processor 214 for controlling the switches 218. The switches 218 are preferably transistors. By providing the plurality of switches 218, any combination of pixels can be combined. For example, signals from pixels A, B, or C may be sent to analog-to-digital converter (ADC) 222 or any combination thereof. Furthermore, a signal from pixel A may be sent to ADC 222 while a signals from pixel C may be sent to ADC 226, wherein the pixels are later combined by the pixel processor 114.

By employing switching circuitry 216 to select any arbitrary pixel combination, the imaging pixel array may be configured “on-the-fly” in various ways depending on the target being scanned or application. Referring to FIG. 2C, an embodiment of a pixel array configuration is illustrated. Here, the individual pixels are diamond-shaped and are configured in a lattice configuration. FIG. 2D illustrates a further pixel array configuration where the rows of pixels are staggered and any two adjacent rows may be added to form a composite signal via autocorrelation and other known techniques to produce a system with much higher effective resolution.

The combination of the pixel signals of each pixel column 210 results in the output of a composite output signal having data corresponding to the imaged barcode or other indicia and also having improved signal-to-noise (S/N) characteristics. Hence, the imaging pixel array 202 is programmable, since the aspect ratio of the imaging pixel array 202 can be altered “on-the-fly” to optimize aspect ratio, thereby increasing the signal-to-noise (S/N) ratio in the composite output signal transmitted to the pixel processor 214 and subsequently to the decoder 318.

The pixel processor 214 determines whether the composite output signal corresponds to a one-dimensional barcode (for example, by analyzing finder patterns, edges, etc. of the barcode). If it does, the composite output signal is transmitted to the decoder 318 where the data of the composite output signal which corresponds to the imaged barcode are decoded.

If the composite output signal does not correspond to a one-dimensional barcode, i.e., the data of the composite output signal corresponds to a two-dimensional barcode, the data are stored in a memory of the pixel processor 214 while awaiting for subsequent data, in order for all the data corresponding to the two-dimensional barcode to be transmitted to the decoder 318. The subsequent data are obtained by moving the barcode or barcode imager 302 relative to each other to image the remaining non-imaged portion of the barcode. The same methodology as described above is then repeated, i.e., the pixel signals of each pixel column 210 or individual pixel 208 are combined to increase the aspect ratio of the imaging pixel array 202 resulting in a composite output signal which is then transmitted to the pixel processor 214. It is contemplated that the processing circuits 212 can be integrated within the pixel processor 214 as a single, integrated chip.

Barcode Imaging System

The imaging circuitries 100, 200 of the first and second embodiments described above can be incorporated in a variety of imaging devices. One such imaging device is an image-based, one-dimensional barcode imaging system as shown by FIG. 3 and designated generally by reference numeral 300.

As shown by FIGS. 3 and 4, the barcode imaging system 300 includes the handheld barcode imager 302 housing one of the imaging circuitries 100, 200 described above and packaged in the form of an imaging engine 303, an illumination source 306 having at least one LED or other light generating device, an aiming source 305 having a laser diode for aiming a laser beam at an optical code (e.g., a barcode) or target to be imaged, control circuitry 308, and communication circuitry 310 interfaced with cable 312 for non-wirelessly transmitting signals to a terminal 313, such as a point-of-sale terminal. Alternatively, the barcode imaging system 300 may be designed for wireless operation. The imaging engine 303 is configured and dimensioned for fitting within a predetermined form factor 313 of the barcode imager 302, such as the SE1200 form factor developed by Symbol Technologies, Inc.

The control circuitry 308 includes a processor 314 for controlling the operation of the barcode imager 302, such as for actuating an image and decode process upon a user pressing a trigger button 316, actuating an actuator (not shown) for moving at least one lens element for focusing the optical code or target, controlling the illumination source 306, the aiming source 305 and communication circuitry 310, for operating the barcode imager 302 in the continuous imaging mode, and for executing a set of programmable instructions for decoding the imaged optical code or target or controlling operation of the decoder 318 for decoding the imaged optical code or target. The decoder 318 can be external to the processor 314 or resident within the processor 314.

The control circuitry 308 further includes a memory 315 for storing pixel output data and other data as described above with reference to the two embodiments and operational instructions, such as the sets of programmable instructions for operating the barcode imager 302 in the continuous imaging mode, capable of being executed by the processor 314. The memory 315 can be external to the processor 314 as shown in FIG. 4 or resident within the processor 314.

The communication circuitry 310 outputs data indicative of the decoded and/or processed optical code or target to an external computing device, such as terminal 313, and receives data, such as data for changing at least one operational parameter of the barcode imager 302 as known in the art. The operational parameters can also be changed by imaging an optical code or target corresponding to at least one operational parameter and decoding and/or processing the imaged optical code or target, and subsequently changing the at least one operational parameter indicative of the decoded and/or processed optical code or target.

Alternatively, various components of the imaging system may be implemented in a single semiconductor device, e.g., a scanner-on-a-chip. Referring to FIG. 5, the scanner-on-a-chip configuration is illustrated. The system 500 includes the imaging circuitry as described above for example an imaging pixel array 502, pixel processor 514 and decoder 518. Other components within the handheld scanner 302 may be on the chip 500, for example, a power management system 552 for managing power usage of the various components of the barcode imager, reference voltage memory 554 for storing various reference voltages, motor controller 556 for actuating at least one lens of the barcode imager, laser controller 558 for controlling a laser or aiming source, and LED drivers 560 for driving an illumination source. Furthermore, the system 500 will include a controller 550 for controlling the various components and the overall operations of the system. For example, ambient light can be measured by the pixel array 502 and the controller 550 can decide how to combine pixels based on received signal strength or, based on ambient light level, the controller 550 can vary the duty cycle of the on chip illumination system (LEDS) via the LED drivers 560 to provide illumination without spending more power than is really needed.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

1. Circuitry for imaging an optical target comprising:
a pixel array having at least two rows of pixels, wherein each pixel forms a pixel column with a corresponding pixel of another row, and wherein each pixel is capable of generating a pixel signal when an image is captured by said imaging pixel array; and
processing circuitry for combining pixel signals for changing an aspect ratio of said pixel array.

2. Circuitry according to claim 1, wherein the processing circuitry outputs a composite output signal having data corresponding to an imaged optical target and capable of being decoded by a decoder.

3. Circuitry according to claim 2, wherein the optical target is a barcode being one of a one-dimensional and a two-dimensional barcode.

4. Circuitry according to claim 1, wherein the processing circuitry outputs pixel output data corresponding to one of the at least two rows of pixels if the processing circuitry determines not to combine pixel signals.

5. Circuitry according to claim 1, wherein the processing circuitry further determines whether pixel output data outputted by the pixel array are decodeable.

6. Circuitry according to claim 5, wherein one or more of the following factors are considered by the processing circuitry for determining whether the pixel output data are decodeable: whether the pixel output data corresponds to a low or high density barcode; amount of ambient lighting; whether the pixel array is tilted or at an angle with respect to the optical target being imaged; the type of surface the optical target being imaged is positioned on; and the distance the imaging pixel array is positioned from the optical target being imaged.

7. Circuitry according to claim 1, wherein the processing circuitry further processes the pixel signals of the at least two rows of pixels to obtain an output signal for each of the at least two row of pixels of the pixel array.

8. Circuitry according to claim 7, wherein the processing circuitry combines the output signals of each of the at least two rows of pixels to obtain a composite output signal for transmitting to a decoder.

9. Circuitry according to claim 7, wherein the processing circuitry transmits to a decoder the signal output signal corresponding to one of the at least two rows of pixels.

10. Circuitry according to claim 1, wherein the processing circuitry includes circuitry for processing pixel signals and a pixel processor for receiving the processed pixel signals.

11. Circuitry according to claim 1, wherein the processing circuitry determines whether the optical target corresponds to a one-dimensional or a two-dimensional bar code symbol.

12. An imaging system for imaging an optical target comprising:
means for initiating an imaging operation for imaging the optical target; and
imaging circuitry for imaging the optical target comprising:
a pixel array having at least two rows of pixels, wherein each pixel forms a pixel column with a corresponding pixel of another row, and wherein each pixel is capable of generating a pixel signal when an image is captured by said pixel array; and
processing circuitry combining pixel signals.

13. The imaging system according to claim 12, wherein the processing circuitry outputs a composite output signal having data corresponding to the imaged optical target and capable of being decoded by a decoder.

14. The imaging system according to claim 13, wherein the optical target is a barcode being one of a one-dimensional and a two-dimensional barcode.

15. The imaging system according to claim 12, wherein the processing circuitry outputs pixel output data corresponding to one of the at least two rows of pixels if the processing circuitry determines not to combine pixel signals.

16. The imaging system according to claim 12, wherein the processing circuitry further determines whether pixel output data outputted by the pixel array are decodeable.

17. The imaging system according to claim 16, wherein one or more of the following factors are considered by the processing circuitry for determining whether the pixel output data are decodeable: whether the pixel output data corresponds to a low or high density barcode; amount of ambient lighting; whether the pixel array is tilted or at an angle with respect to the optical target being imaged; the type of surface the optical target being imaged is positioned on; and the distance the imaging pixel array is positioned from the optical target being imaged.

18. The imaging system according to claim 12, wherein the processing circuitry further processes the pixel signals of the at least two rows of pixels to obtain an output signal for each of the at least two row of pixels of the pixel array.

19. The imaging system according to claim 18, wherein the processing circuitry combines the output signals of each of the at least two rows of pixels to obtain a composite output signal for transmitting to a decoder.

20. The imaging system according to claim 18, wherein the processing circuitry transmits to a decoder the output signal corresponding to one of the at least two rows of pixels.

21. The imaging system according to claim 12, wherein the processing circuitry includes circuitry for processing pixel signals and a pixel processor for receiving the processed pixel signals.

22. The imaging system according to claim 12, wherein the processing circuitry determines whether the optical target corresponds to a one-dimensional or a two-dimensional bar code symbol.

23. The imaging system according to claim 12, wherein the processing circuitry is provided within an imaging engine dimensioned for fitting within a predetermined form factor of a barcode imager.

24. The imaging system according to claim 12, wherein the processing circuitry combines a different combination of pixels for each subsequent scan of the target.

25. An imaging engine for imaging an optical target, said imaging engine comprising:
a pixel array having at least two rows of pixels, wherein each pixel forms a pixel column with a corresponding pixel of another row, and wherein each pixel is capable of generating a pixel signal when an image is captured by said imaging pixel array; and
processing circuitry for combining pixel signals for changing the aspect ratio of said imaging pixel array.

26. The imaging engine according to claim 25, wherein the processing circuitry outputs a composite output signal having data corresponding to the imaged optical target and capable of being decoded by a decoder.

27. The imaging engine according to claim 25, wherein the processing circuitry outputs pixel output data corresponding to one of the at least two rows of pixels if the processing circuitry determines not to combine pixel signals.

28. The imaging engine according to claim 25, wherein the processing circuitry further determines whether pixel output data outputted by the pixel array are decodeable.

29. The imaging engine according to claim 28, wherein one or more of the following factors are considered by the processing circuitry for determining whether the pixel output data are decodeable: whether the pixel output data corresponds to a low or high density barcode; amount of ambient lighting; whether the pixel array is tilted or at an angle with respect to the optical target being imaged; the type of surface the optical target being imaged is positioned on; and the distance the imaging pixel array is positioned from the optical target being imaged.

30. The imaging engine according to claim 25, wherein the processing circuitry further processes the pixel signals of the at least two rows of pixels to obtain an output signal for each of the at least two row of pixels of the pixel array.

31. The imaging engine according to claim 30, wherein the processing circuitry combines the output signals of each of the at least two rows of pixels to obtain a composite output signal for transmitting to a decoder.

32. The imaging engine according to claim 30, wherein the processing circuitry transmits to a decoder the output signal corresponding to one of the at least two rows of pixels.

33. The imaging engine according to claim 25, wherein the processing circuitry includes circuitry for processing pixel signals and a pixel processor for receiving the processed pixel signals.

34. The imaging engine according to claim 25, wherein the processing circuitry determines whether the optical target corresponds to a one-dimensional or a two-dimensional bar code symbol.

35. The imaging engine according to claim 25, wherein the imaging engine is dimensioned for fitting within a predetermined form factor of a barcode imager.

36. The imaging engine according to claim 25, wherein the processing circuitry combines a different combination of pixels for each subsequent scan of the target.

37. A semiconductor device comprising:
a pixel array having at least two rows of pixels, wherein each pixel forms a pixel column with a corresponding pixel of another row, and wherein each pixel is capable of generating a pixel signal when an image is captured by the pixel array;
processing circuitry for combining pixel signals for changing an aspect ratio of said pixel array;
a power management system for managing power usage of the semiconductor device;
a reference voltage system;
a first controller for controlling a laser or aiming source;
a driver for driving an illumination source; and
a second controller for controlling overall operations of the semiconductor device.

38. The semiconductor device according to claim 37, wherein the processing circuitry includes a decoder for determining whether to combine the pixel signals.

39. The semiconductor device according to claim 37, wherein the second controller determines whether to combine the pixel signals.

40. Circuitry for imaging an optical target comprising:
a pixel array having at least two rows of pixels disposed on a semiconductor substrate, wherein each pixel forms a pixel column with a corresponding pixel of another row, and wherein each pixel is capable of generating a pixel signal when an image is captured by said pixel array; and
circuitry means disposed on said substrate to selectively combine pixels across both row and column boundaries.

41. The circuitry according to claim 40, wherein upon combining pixels, an aspect ratio of the pixel array is varied from an initial aspect ratio.

42. The circuitry according to claim 40, further comprising a decoder disposed on said substrate for determining whether to combine the pixel signals.
